(19) United States
(12) Patent Application Publication
(10) Pub. No.: US 2012/0046990 A1
(43) Pub. Date: Feb. 23, 2012

(54) PROCESS AND SYSTEM FOR CREATING A COMPATIBILITY RATING USED BY ENTREPRENEURS TO ALLOW THEM TO SELECT BUSINESS OPPORTUNITY PROVIDERS

(75) Inventor: Francisco Jauier Codina, Miramar, FL (US)

(73) Assignee: NEURS LLC, Palo Alto, CA (US)

(21) Appl. No.: 13/212,999

(22) Filed: Aug. 18, 2011

Related U.S. Application Data
(60) Provisional application No. 61/374,983, filed on Aug. 18, 2010.

(51) Int. Cl. G06Q 10/00

(52) U.S. Cl. 705/7.28

(57) ABSTRACT

The present invention generally relates to computer implemented methods for providing a compatibility rating. In particular, the present invention relates to a process that is computer implemented in which an entrepreneur obtains a score (e.g., a numerical expression) of their probability of having a prosperous and profitable experience with a business opportunity, franchise, direct sales company, or independent business idea provider (hereinafter referred as a ‘business opportunity provider”) based on shared compatibility.

### CROSS REFERENCE TO RELATED APPLICATIONS

This application claims the benefit of U.S. Provisional Patent Application No. 61/374,983 filed Aug. 18, 2010, the entire disclosure of which is incorporated herein by reference.

### FIELD OF INVENTION

The present invention generally relates to computer implemented methods for providing a compatibility rating. In particular, the present invention relates to a process that is computer implemented in which an entrepreneur obtains a score (e.g., a numerical expression) of his probability of having a prosperous and profitable experience with a business opportunity, franchise, direct sales company, or independent business idea provider (hereinafter referred as a ‘business opportunity provider”) based on shared compatibility.

### BACKGROUND OF THE INVENTION

As of today, there is no service available in the marketplace that allows people interested in starting a business, or that are considering a business relationship with a franchise, direct selling firms, networking marketing, party-plan, and multi-level marketing (MLM) companies, to know which business opportunity would be most compatible with them.

There are numerous websites and business services that rank or provide a directory of business opportunities by categories (hereinafter “ranking directories”). These ranking directories will often try to suggest that an entrepreneur look into a business opportunity solely on the basis of the money he has to invest or his work experience and/or interest. Other ranking directories simply push the business that provides the service with the most advertising revenue. These ranking directories cannot and do not account for the large number of variables that can determine whether a person could and would be compatible with a business opportunity provider or specific business idea (with such a limited number of inquiries from their users and narrow search criteria).

The large number of variables involved in determining the compatibility that a person has with a possible business venture has made it practically impossible to predict the level of success of a business relationship, and thus no one in the current art has successfully generated a system for predicting the level of success of a business relationship through the use of these large number of variables.

Since starting a new business is a risky venture, not having reliable information as to whether a particular possible business venture will succeed or whether the level of success attainable by a business relationship is worth the time and effort spent on the venture. In many cases, these unknowns keep otherwise interested entrepreneurs or investors out of the market.

Therefore, there is a need in the art for a system and method for providing people with a quantifiable compatibility score that accounts for the complexity of the many variables that can account for and identify the potential for business success. These and other features and advantages of the present invention will be explained and will become obvious to one skilled in the art through the summary of the invention that follows.

### SUMMARY OF THE INVENTION

Accordingly, it is an object of the present invention to provide a system and method or generating a score or numerical expression representing the probability of compatibility that an individual will have with commonly available business opportunities and/or business ideas, based at least in part on the gathering and analyzing information from one or more data sources.

According to an embodiment of the present invention, the analyzed information is assessed against a large number of variables that are used to determine a probability of success an entrepreneur would have with a particular business opportunity.

According to an embodiment of the present invention, data sources may include an individual's profile, a questionnaire comprised of a wide range of questions into matters that are relevant to the formation of this score and other publicly or privately accessible data stores.

In one embodiment, the invention also includes identifying the areas that most highly predict compatibility and augmenting those areas mathematically, while at the same time, significantly diminishing the valuations of the areas where a lack of compatibility exists. In this manner, disparity between scores may be made more pronounced.

Additionally, as more than one business opportunity may be appropriate for a particular entrepreneur, the present invention provides a means for allowing an entrepreneur to narrow the business opportunities that are available to him based on his goals and expectations using the variables described above.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates a schematic overview of a networked system for carrying out the system and methods herein described, in accordance with an embodiment of the present invention;

FIG. 2 illustrates an exemplary embodiment of a profile questionnaire that is answered by entrepreneurs, in accordance with an embodiment of the present invention;

FIG. 3 illustrates an exemplary embodiment of a profile questionnaire that may be answered by the business opportunity providers, in accordance with an embodiment of the present invention;

FIG. 4 illustrates an exemplary embodiment of a formula used to assign a number to each response received from a user and how the formula is programmed into the online business service to generate a database of response, in accordance with an embodiment of the present invention;

FIG. 5 illustrates an exemplary embodiment of how mathematical results are added to create a total number for each section or area of a profile questionnaire, in accordance with an embodiment of the present invention;

FIG. 6 illustrates an exemplary embodiment of how a first mathematical formula is used by an exemplary embodiment of the present invention to rank results from each section or area of a profile questionnaire as either a strong compatibility number, neutral compatibility number, or weak compatibility number, in accordance with an embodiment of the present invention;

FIG. 7 illustrates an exemplary embodiment of a second mathematical formula used to calculate variable values of compatibility using a compatibility number obtained using a first mathematical formula, in accordance with an embodiment of the present invention;

FIG. 8 illustrates an exemplary embodiment of a current minimum and maximum numerical values are achieved by using a second mathematical formula, when adding all variables within the second formula, and how a numerical ranking is translated to an A through F rating, in accordance with an embodiment of the present invention;

FIG. 9 Illustrates an exemplary embodiment of an entrepreneur's score with thirty business opportunities and results in a graph depicting which business opportunity provider the entrepreneur is more compatible with, in accordance with an embodiment of the present invention; and

FIG. 10 illustrates an exemplary process flow of how an entrepreneur's information would be processed by a computing device to allow him to select a proper business opportunity provider, in accordance with an embodiment of the present invention.

### DETAIL DESCRIPTION

The present invention generally relates to computer implemented methods for providing a compatibility rating. In particular, the present invention relates to a process that is computer implemented in which an entrepreneur obtains a score (e.g., a numerical expression) of his probability of having a prosperous and profitable experience with a business opportunity, franchise, direct sales company, or independent business idea provider (hereinafter referred as a ‘business opportunity provider”) based on shared compatibility.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

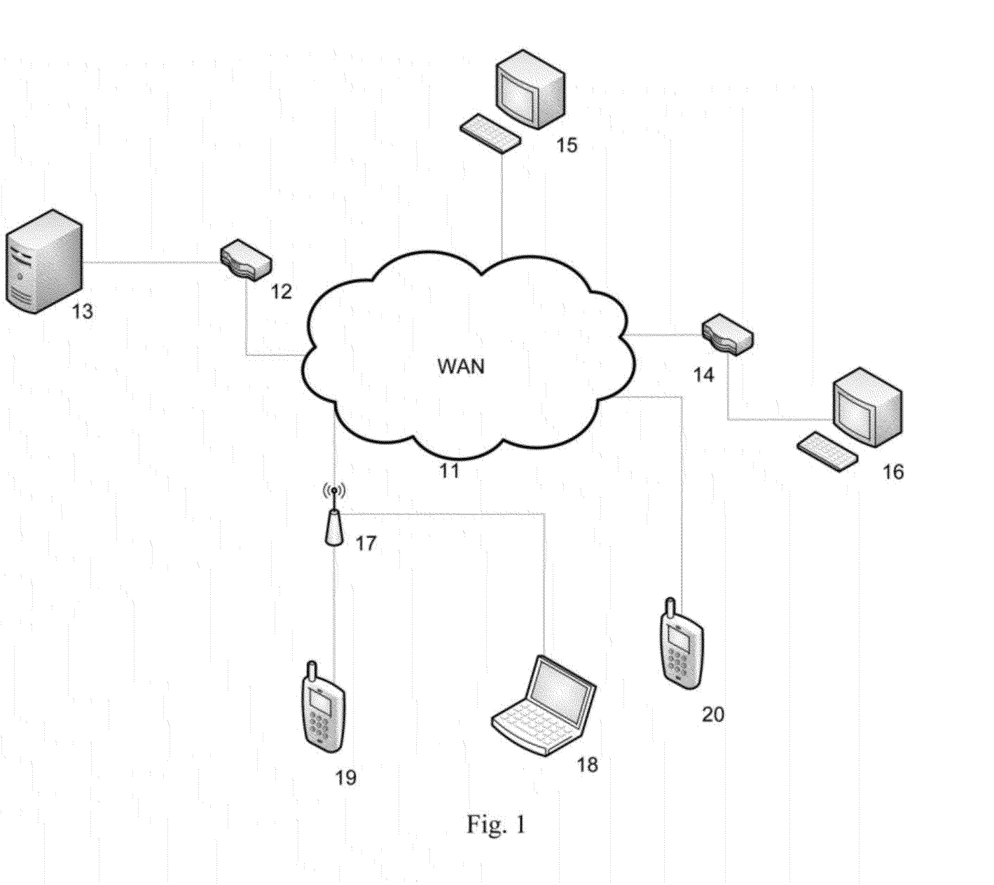

Referring to FIG. 1, a schematic overview of a system in accordance with an embodiment of the present invention is shown. The system is comprised of one or more application servers 13 for electronically storing information used by the system. Applications in the application server 13 may retrieve and manipulate information in storage devices and exchange information through a WAN 11 (e.g., the Internet).

According to an exemplary embodiment, as shown in FIG. 1, exchange of information through the WAN 11 or other network may occur through one or more high speed connections directed through one or more routers 12. Router(s) 12 are completely optional and other embodiments in accordance with the present invention may or may not utilize one or more routers 12. One of ordinary skill in the art would appreciate that there are numerous ways application server 13 may connect to WAN 11 for the exchange of information, and embodiments of the present invention are contemplated for use with any method for connecting to networks for the purpose of exchanging information.

Members may connect to application server 13 via WAN 11 or other network in numerous ways. For instance, a Member may connect to the system i) through a computing device 15 directly connected to the WAN 11, ii) through a computing device 16 connected to the WAN 11 through a routing device 14, iii) through a computing device 18 or 19 connected to a wireless access point 17 or iv) through a computing device 20 via a wireless connection (e.g., CDMA, GMS, 3G, 4G) to the WAN 11. One of ordinary skill in the art would appreciate that there are numerous ways that a member may connect to application server 13 via WAN 11 or other network, and embodiments of the present invention are contemplated for use with any method for connecting to Server 13 via WAN 11 or other network.

According to an embodiment of the present invention, an individual or organization may signup to become a member of the system herein provided. In an exemplary embodiment, an individual or organization would go through a registration process, whereby they would provide identifying information to be stored in application server 13. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes. In an alternate embodiment, no user registration is required and any information required will be requested “on-the-fly”. “On-the-fly” or on demand data may be temporarily or permanently stored for later use as required by the system and methods herein described.

In general, the systems and methods herein described define functions and operations of a process for determining compatibility between entrepreneurs and possible business opportunity providers using information received from one or more data sources. Data sources include, but are not limited to, profile data, remote data stores (e.g., databases, social media accounts, news accounts), local data stores (e.g., cookies, cache, locally stored files and documents) and questionnaires. One of ordinary skill in the art would appreciate that there are numerous types of data sources that could be used with embodiments of the present invention and embodiments of the present invention are contemplated for use with any type of data source.

According to an embodiment of the present invention, one particularly useful type of data source that is used with the system and methods herein described are questionnaires. In an exemplary embodiment, Questionnaires are assigned one or more numerical values. The questionnaires are answered by both entrepreneurs and business opportunities providers. The system receives the responses from the entrepreneurs and business opportunities providers and approximates a compatibility of an entrepreneur to a business opportunity provider using one or more of a pre-programmed numerical scoring system or a dynamic numerical scoring system that is assigned to questionnaires given both to the entrepreneur and the business opportunity provider. The system may be further configured to augment compatibility scores in one or more manners which are more fully described below.

In an exemplary embodiment of the present invention, an application server 13 in configured to access one or more data sources, store one or more questionnaires, process one or more questionnaires, store values related to a user's or business opportunities provider's responses to a questionnaire, augment values and allow users of the system to review the business opportunity providers stored in the system. Each business opportunity provider may be given a specific value based on a compatibility value that corresponds to the entrepreneurs answers to a questionnaire.

By providing this compatibility value, the system and methods of the present invention allows entrepreneurs to determine which business opportunities are most compatible to their goals. The system and methods presented herein are configured in such a manner that success in a business can be pre-determined through the review and analysis of a large number of variables. Variables include, but not limited to, personality, skills, suitability of a business for a particular entrepreneur and vice versa. In addition, the probability of adaptability of that entrepreneur to a business being proposed and the expectation the entrepreneur has of the business.

Another important aspect of the invention is the scoring and/or weighting each of the large number of variables involved in determining the compatibility that an entrepreneur has with a possible business venture. Through a series of formulas and business methods, the system and methods herein described are configured to provide a score or mathematical formula to allow an entrepreneur to see if he is compatible with a business opportunity prior to investing a significant amount of time and money in researching the business opportunity.

### Exemplary Embodiments

According to an embodiment of the present invention, once the information has been received from the one or more data sources, the system is configured to process the data and create a first value score, using a first mathematical formula that is designed to help an entrepreneur and/or a business opportunity provider make informed decisions as to the entrepreneurs and the business opportunity provider's potential for involvement.

According to an embodiment of the present invention, the system is further configured to perform a second process that uses a second mathematical formula that incorporates the first value score to obtain a second value score. The second mathematical formula augments the mathematical valuation of a portion or area of the profile where the person is extremely compatible with a business, while subtracting from the formula those portions or areas where there was an obvious incompatibility. By creating a greater disparity between the numbers, the second process provides a significant reduction in the possibility that an entrepreneur shall select a business opportunity provider that will not be compatible.

According to an embodiment of the present invention, the system and methods herein described may be applied to each of the business opportunities and ideas available to or stored in the system or related data sources or some subset thereof. The system may be further configured to transmit and/or display the results to the entrepreneur. The results may be organized, sorted and filtered in a manner such that the results are easily understandable and comprehendible by the entrepreneur.

As described above, the first and second value scores and an associated ranking are generated from the comparison of the information provided by to the system via the one or more data sources associated with an entrepreneur and/or a business opportunity provider. According to an exemplary embodiment of the present invention, the system herein described may accomplish this by providing an entrepreneur and/or an business opportunity provider one or more profile questionnaires that contain the same or similar content.

According to an embodiment of the present invention, questions may be written in such a manner that an entrepreneur can read the questions from his perspective and a business opportunity provider can read the questions from his perspective. Alternatively, the questions may be presented to an entrepreneur or a business opportunity provider based on how they identify themselves in previous stages of interaction with the system (e.g., during registration).

According to an embodiment of the present invention, the system may be configured to allow an entrepreneur to look for his ideal business opportunity provider and a business opportunity provider may look for the ideal entrepreneur. In an exemplary embodiment, questions that are presented to an entrepreneur or a business opportunity provider may be comprised of the same available set of answers, whereby if an entrepreneur chose answer 1 of a question as does the business opportunity provider, then they both would be in complete agreement over the answer to the question posed. This method of questions and answers provides a more likely approximation of two different perspectives between individuals, than a numerical answer system of 1-5, whereby the individual is completely guessing at their level of interest or agreement with a number to a particular question.

According to an embodiment of the present invention, each questionnaire may be comprised of a plurality of inquiries into matters which are relevant to each individual in deciding what business (or area) he should dedicate his time, money, and resources to. The inquiries can have numerical answers; but are mostly answered with written descriptions that have a diverse range, from agreeing with the question, to a total disagreement, and in between. In addition, questions could be answered by multiple choice, with the option to select as many as 30 answers (e.g., checking off which hobbies a person has done in the past or has an interest in)and which hobbies a business opportunity would considered to be a valuable asset if an entrepreneur either practiced or had an interest in). The process is used to help identify an area for which a particular entrepreneur or business opportunity provider

According to an embodiment of the present invention, answers to the questions are compared and a number or other numeric value is assigned to each question (i.e., the first value). A total number, grouped by the number of questions in each of the section or areas, is then added to determine whether a given area has a strong, neutral or weak compatibility score. Based on this determination, the system is configured to utilize the total number achieved for that particular area or portion of the profile and augment and/or diminish the total number to strengthen numerically the areas that are considered compatible while reducing the number when there are signs that an obvious incompatibility exists.

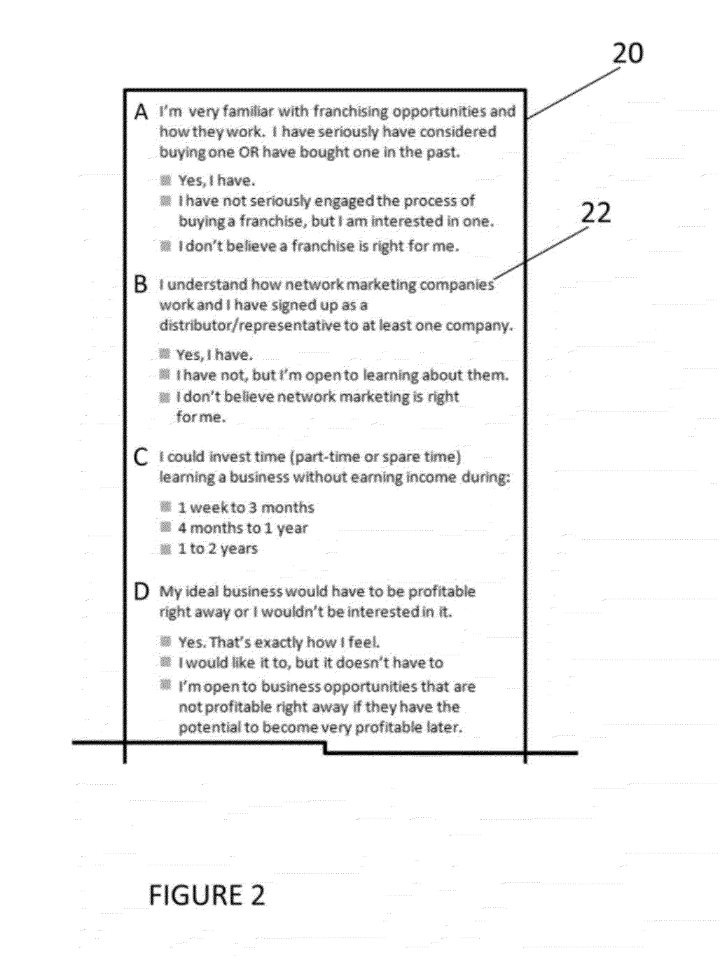

Turning now to FIG. 2, an exemplary embodiment of a questionnaire given to an entrepreneur is shown. The questionnaire 20 asks a series of inquiries 22 that can be answered with a number of possibilities. For instance, the inquiry, “I'm very familiar with franchising opportunities and how they work. I have seriously considered buying one OR have bought one in the past” is followed by a series of answers, and the entrepreneur taking the questionnaire is instructed to choose the answer that best applies to him. The entrepreneur provides an answer by checking off or clicking on the response that best describes how he feels about the inquiry proposed. For instance, choosing the first answer, “Yes, I have”—would indicate that the entrepreneur is particularly attracted to a franchised business opportunity.

Because the answer to each question will vary from entrepreneur to entrepreneur, each inquiry and the associated answers are often referred to as variables. This profile questionnaire 20 can be completed for the purpose of generating enough data for the system to calculate a rating of the entrepreneur when it comes to each business opportunity provider available to the system (e.g., stored in one or more data sources). For instance, the system can be configured to provide a large number of entrepreneurs a profile questionnaire 20. Answers to the profile questionnaire 20 provided by the large number of entrepreneurs can then be used to compare results with the same question posed to the business opportunity providers.

In an exemplary embodiment, the system can be configured to provide the profile questionnaire to an entrepreneur and/or business opportunity provider in the form of one or more web pages after the entrepreneur or business opportunity provider has registered with the system. In addition, the system may be configured to receive additional information or other data that may be converted into a value associated with one or more of the large number of variables from one or more data sources as described above. For instance, information may be pulled from an entrepreneur's social media profiles or posts, local cache, stored cookies and files provided to the system. In this manner, the answers given by the entrepreneur on one or more questionnaires may be compared to information pulled from other data sources. For instance, at a basic level, certain profile information can be confirmed (e.g., age, location, gender, hobbies) and at a more in depth level, detailed information and variables can be checked for certainty (e.g., natural language searches run against information stored in browser caches to check for searches an entrepreneur has recently made in relation to particular business opportunities).

According to an embodiment of the present invention, after the entrepreneur submits a completed questionnaire to the system, the system may be configured to provide the entrepreneur with a steady daily delivery of the highest ranked business opportunity providers, if he so chooses. Alternatively, an entrepreneur may be alerted when a business opportunity provider is identified that has a value that meets or exceeds a certain threshold value. In this manner, the entrepreneur's answers are stored in the system and utilized to create real-time dynamic ratings that can then be compared to other business opportunity provider ratings.

According to an embodiment of the present invention, an entrepreneur profile questionnaire and/or the registration process that allows a connection to the system can also request that the entrepreneur submit preliminary information. Preliminary information is information that is obtained from the entrepreneur to complete the registration process. This information could also be used as part of the profile questionnaire 20, to further refine the compatibility process. As previously noted, this information may also be obtained from one or more remote or local data sources accessible by the system.

The preliminary information can include, but is not limited to, the entrepreneur's work experience, gender, interests, location, age, picture, religion and business. The entrepreneur can also have the option of writing a short blurb about himself The profile questionnaire and/or the registration process can also request additional information and inquiries to further define the most compatible business opportunities for the entrepreneur. The entrepreneur profile questionnaire 20 need not be constant and, according to an exemplary embodiment, may be dynamic based on one or more factors. For instance, the system may be configured to dynamically identify that certain inquiries 22 are less effective at revealing compatibility, these inquiries 22 can be dropped from the profile questionnaire 20. Alternatively, the same method can be accomplished manually. Additionally, the system may be configured to add new questions to the entrepreneur profile questionnaire 20 dynamically to find out whether the new questions add insight into potential compatibility between an entrepreneur and a business opportunity provider. Alternatively, the same method can be accomplished manually. As described above, the answers to the entrepreneur profile questionnaire 20 are used to calculate the compatibility with business opportunities providers.

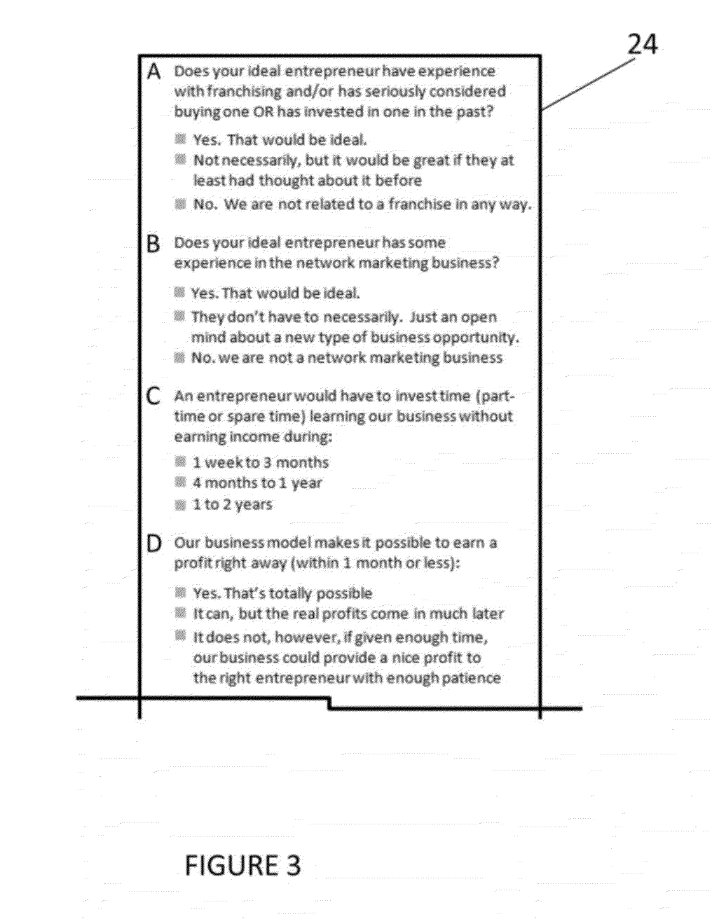

Turning now to FIG. 3, an exemplary embodiment of a business opportunity provider profile questionnaire 24 (hereinafter the BOP questionnaire) is shown. The BOP questionnaire is to be completed by business opportunity providers and may be stored on the system for present or future use. The questions submitted by the business opportunity providers correspond to the entrepreneur questions. In an exemplary embodiment, the questions may be slightly changed so that the business opportunity provider can answer the same questions submitted to the entrepreneur but from a business opportunity provider perspective. For instance; if an entrepreneur answered with the first response to question A and the business opportunity provider also responded to question A choosing the very first answer available, the system may be configured to conclude the there would be a strong compatibility between the entrepreneur and the business opportunity provider. Conversely, if the entrepreneur answered questions A with the third possible response, and the business opportunity provider answered the same question with the first response, a negative, compatibility would be the presumed with regards to this question.

According to an alternate embodiment of the present invention, rotating questions may be used in order to provide complexity and prevent entrepreneurs from reaching a desired result. In this manner, a single variable may be associated with a plurality of questions, each question to be rotated through and provided to an entrepreneur or business opportunity provider at random.

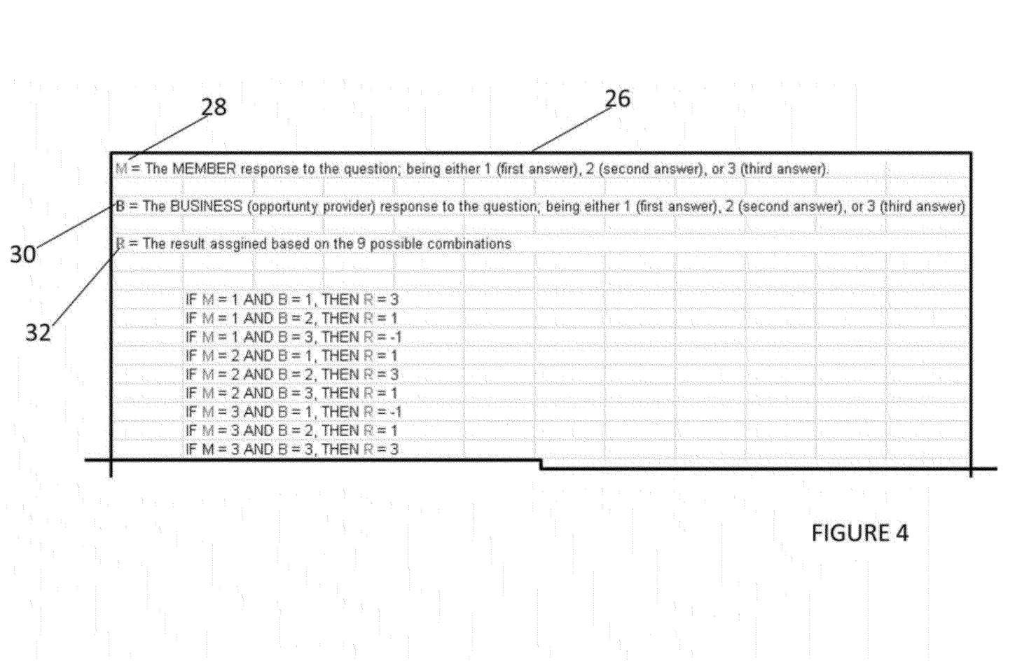

Turning now to FIG. 4, an exemplary embodiment of the first mathematical formula 26 used to assign a first value score to each response to the profile questionnaires 20 as it is compared to the same responses provided by the business opportunity provider in its profile questionnaire 24 is shown. For instance, if an entrepreneur 28 chooses the first response in question A of the profile questionnaire 20 and the business opportunity provider 30 chooses the same response in its profile questionnaire 24, then an assigned first value score is assigned to the first mathematical formula as a result 32. In this exemplary embodiment, a total of 9 possibilities exist in this first mathematical formula. One of ordinary skill in the art would appreciate that any complexity of formulas may be utilized, and embodiments of the present invention are contemplated for use with any formula complexity.

According to an embodiment of the present invention, the first mathematical formula 26 need not be constant and can change with time, as more answers, above and beyond the three hereby illustrated, are added or a different first value score is assigned to the result 32. The resulting first value score 32 assigned to each question, based on the first value formula 26 described is stored and utilized by the system which is configured to record every result 32 from each entrepreneur and business opportunity provider in the system's data sources, and saves the entry for further calculations that will be performed in the second mathematical formula described below.

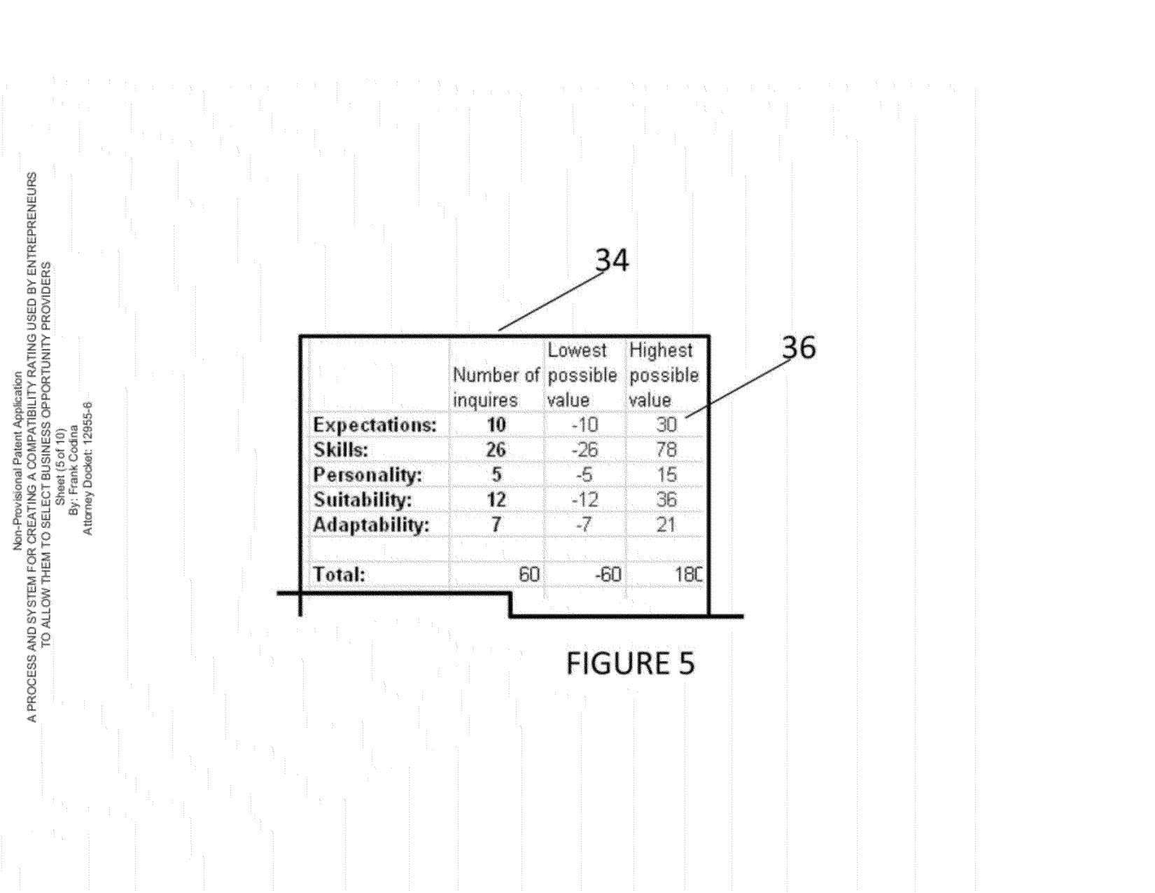

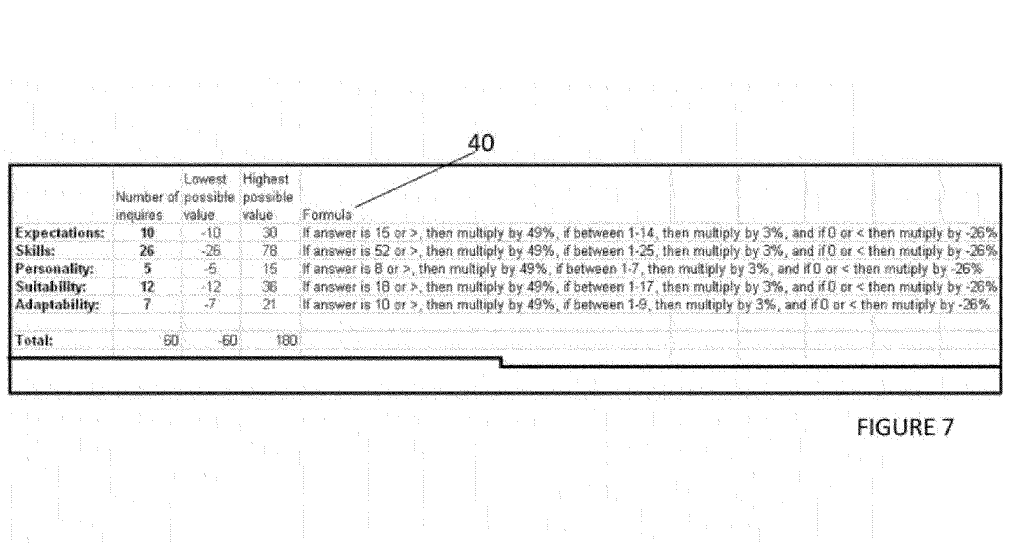

Turning now to FIG. 5, an exemplary embodiment of the total number of inquiries 34 for each section of the profile questionnaire 20 and the numerical minimums and maximums that could be achieved by grouping together all of the answers calculated using the formula 26 in FIG. 4 for each of the areas or sections of the profile questionnaire 20 is shown. The total number of inquiries could change if additional inquiries are added or taken out of the profile questionnaire 20. In this illustration, the maximum number that a entrepreneur and a business opportunity could score using the formula 26 in FIG. 4 if both their answers are identical for each of the questions is 30 for Expectation, 78 for Skills, 15 for Personality, 36 for Suitability, and 21 for Adaptability. Inversely, the minimum possible number that could be scored is −10 for Expectation, −26 for Skills, −5 for Personality, −12 for Suitability, and −7 for Adaptability. The resulting numerical value 36 assigned to each group of questions, based on the formula 26 described is programmed in a software application that immediately records the grouped results 36 from each entrepreneur and business opportunity provider in the services' database, and saves the entry for further calculations that will be performed in FIG. 7 in conjunction with a rating of weak, strong, or neutral for each of the areas mentioned above.

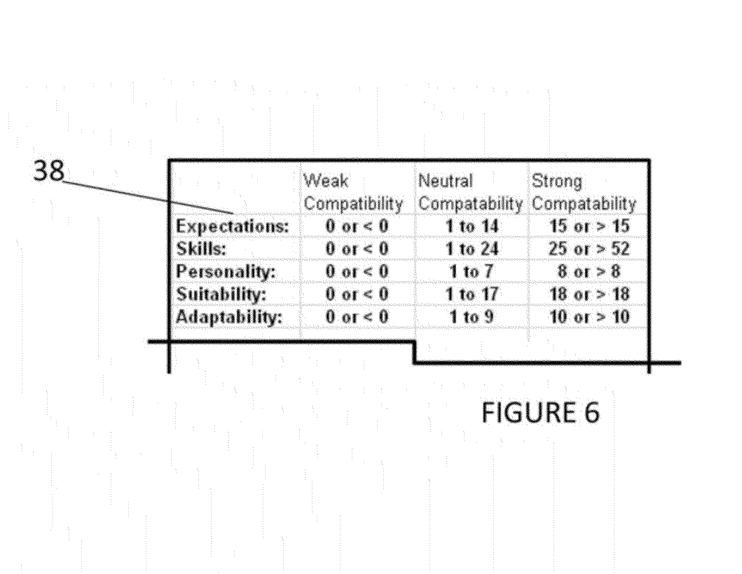

Turning now to FIG. 6, an exemplary embodiment of a process by which the system assigns a strong, weak, or neutral compatibility score to the numerical value derived by applying the formula 26 to each of the inquiries grouped together 38 as explained in FIG. 5 is shown.

Turning now to FIG. 7, an exemplary embodiment of how a resulting numerical value 36 assigned to each group of questions is then re-calculated based on a formula 40 that attempts to augment the number where a high compatibility is shown by 49%, while subtracting 26% from the results 36 if they are or less. For results 36 that are considered neutral, a slight increment of 3% is added to the formula 40. This formula 40 need not be constant and the system can be configured to have the formula 40 change dynamically, manually or any combination thereof. For instance, as the system finds that certain inquiries 22 are less effective at revealing compatibility, these inquiries 22 can be dynamically dropped from the profile questionnaire 20, thus changing the formula 40. Additionally, the system can be configured to add new questions to the profile questionnaire to find out whether the new questions add insight into possible compatibility of entrepreneurs and the business opportunities. Finally, the system can be configured to change percentages used to diminish or augment the formula 40 if the system identifies that doing so will further create the disparity in the range of scores necessary for the entrepreneurs to make a useful decision as to which business opportunity providers could be best suited for them. In any case, the resulting numerical value 32 assigned to each question, based on the formula 26 described is configured in the system to immediately record every result 32 from each entrepreneur and business opportunity provider in the system's data sources and saves the entry for further calculation that may be performed in a formula described in FIG. 5.

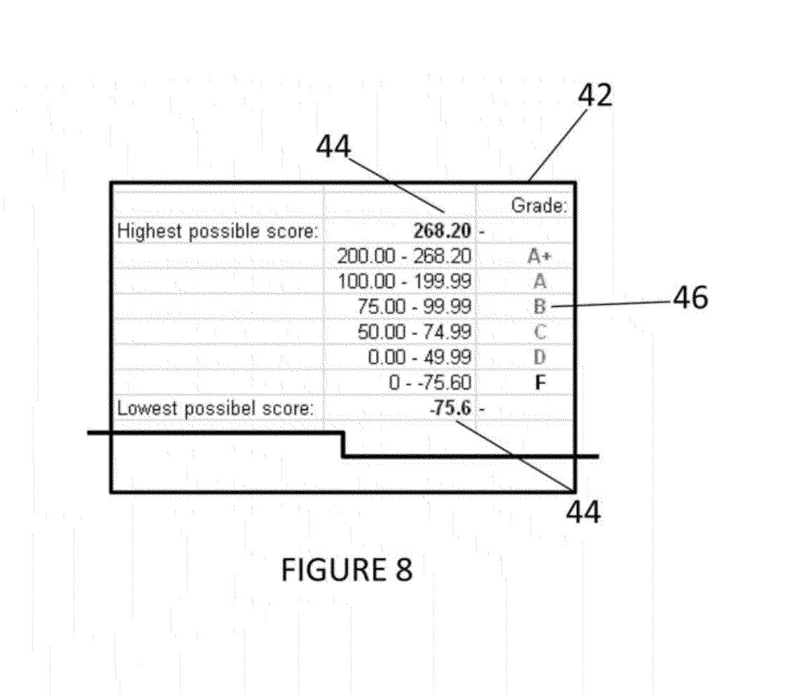

Turning now to FIG. 8, an exemplary embodiment is shown whereby the maximum and minimum score possible 44 that the system could potentially assign to a business opportunity provider based on the formula 26, explained in FIG. 4, when combined by categories as explained in FIG. 5 and after applying the second formula 40, to augment or diminish the most compatible or incompatible areas.

According to an embodiment of the present invention, the process 42 may then assign a grading system 46 starting at A+ and ending at F to a diverse range of possible mathematical conclusions. This grading system is used to understand the likelihood of a compatibility between the entrepreneur and the business opportunity provider. Alternatively, the grading system could be, but is not limited to, numeric values, alphanumeric values, percentages or other visual representations. One of ordinary skill in the art would appreciate that the grading system can be based on numerous scales in accordance with embodiments of the present invention, and embodiments of the present invention are contemplated for use with any scale.

According to an embodiment of the present invention, the grading system 42 need not be static. For instance, the system could be configured to find certain inquiries 22 that are less effective at revealing compatibility, these inquiries 22 can be dropped from the profile questionnaire 20, thus changing the rating formula.

According to an embodiment of the present invention, the system can be configured to add new questions to the profile questionnaire to find out whether the new questions add insight into possible compatibility of entrepreneurs and the business opportunity providers. Questions may be added dynamically, manually or any combination thereof. In addition, the system may be configured to change the percentages used to subtract or augment the formula 40 if the system identifies the opportunity to improve the disparity in the range of ratings necessary for the entrepreneurs to make a useful decision as to which business opportunity providers could be potentially best suited for them. This will in turn potentially change the grading system 46 and create the need to alter the grading (e.g., A+ to F) for a different number of numeral ranges. In any case, the resulting numerical score, both maximums and minimums 44, would change. These new ranges may be calculated automatically by the system, manually provided to the system or any combination thereof. Regardless, the newly recorded ranking would be stored in data sources of the system.

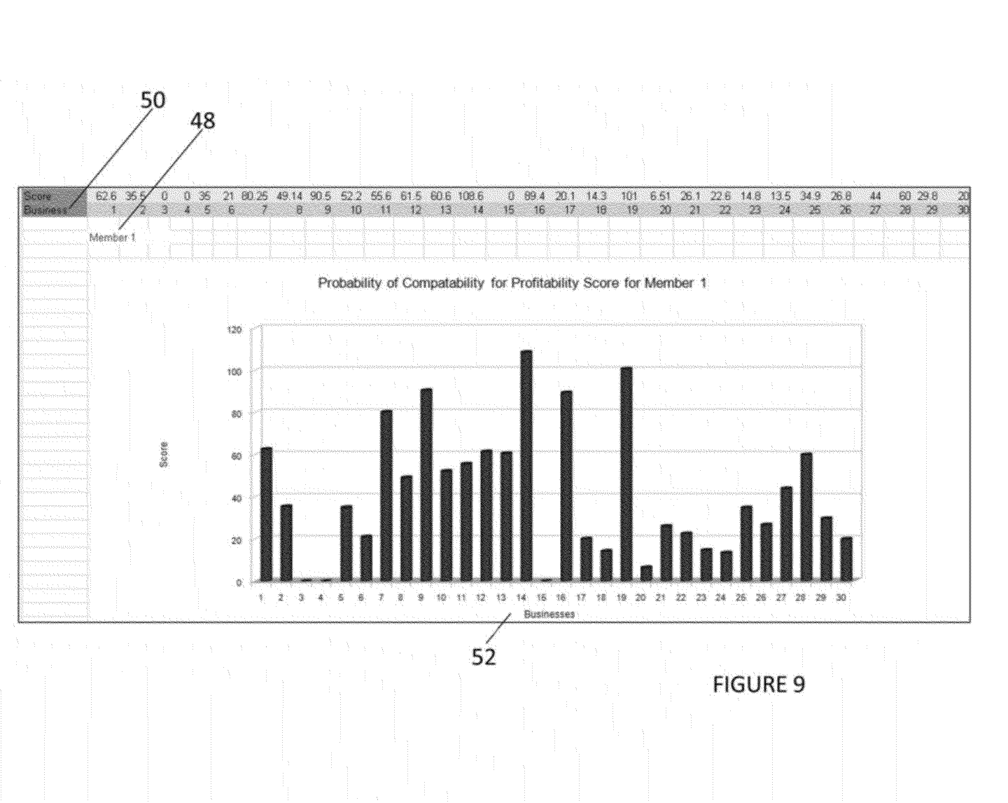

Turning now to FIG. 9, an exemplary embodiment of a randomly chosen test subject 48, an entrepreneur using the present invention, and how utilizing the invention detailed through the entire process described above, obtained a rating score that allowed him to select a business opportunity provider, is shown. The sample shows 30 business opportunity providers, for the purpose of illustrating 52 the diverse range of scores and how those scores could be interpreted to signify to the entrepreneur that the probability of a compatibility to those business opportunity providers is either high or low, and thus help the entrepreneur in the process of deciding which business opportunity provider he should dedicate more time and resources to, researching, or doing the necessary due diligence with. In this example, the entrepreneur should strongly consider researching further the 14th and19th business opportunity provider as scores of 101.8 and 101, respectably resulted, giving these two business opportunity providers an A grade using our above described grading system 46. In addition, in this example, the entrepreneur would be encouraged to review and research the 3 business opportunity providers that would be graded B by the present invention's grading system 46 as these business opportunity providers may be of interest to the entrepreneur. Conversely, the system provided the entrepreneur with a grading of D or F to approximately 20 business opportunity providers because of incompatibility as determined by the present invention, it would be not be advisable for the entrepreneur to dedicate too much time to business opportunity providers receiving a grade of a D or an F.

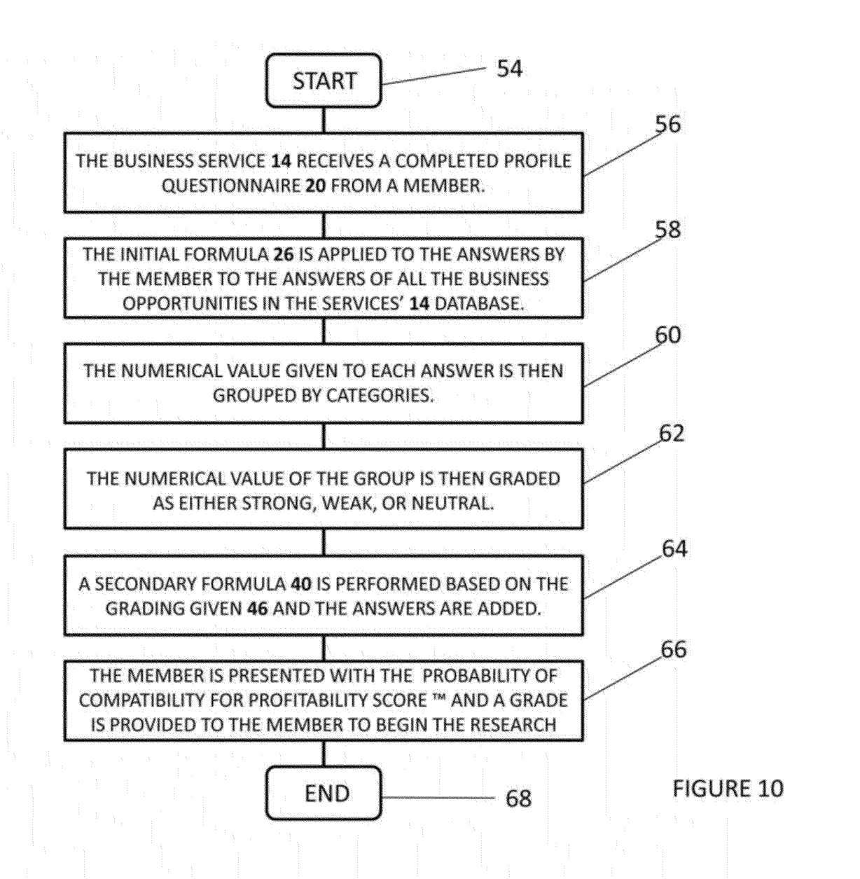

Turning now to FIG. 10, an exemplary method of arriving at an entrepreneur's rating, is shown. The method starts at block 54 when an entrepreneur begins to complete a profile questionnaire 20 for the purpose of allowing the system to perform the process of advising the entrepreneur of the highest ranked business opportunity providers available in the data sources of the system.

At process block 56 the completed profile questionnaire 20 is received from the entrepreneur. The entrepreneur preferably employs a computing device to transmit the survey 20 to the system.

At process block 58, the entrepreneur's answers are compared to the answers provided by the business opportunity provider in the server, and the formula 26 by which a numerical value is given based on the answers to each question that both the entrepreneur and the business opportunity provider answered. The resulting numerical value is saved in a data source of the system and is based on the entrepreneur's answers.

At process block 60, the answers and related numerical values are grouped together by category (Expectations, Skills, Personality, Suitability, and Adaptability) as explained on FIG. 5.

At process block 62, the numerical answer for each group as described in FIG. 5 is graded as either a Strong, Weak, or given a Neutral rating as described in FIG. 6.

At process block 64, the numerical answers for each group is then recalculated using a secondary formula 40 to augment the areas of high compatibility and diminish the scores where a low compatibility exits. The result for each category is then added and the entrepreneur rating is recorded as a relationship between the entrepreneur and the business opportunity provider availed on the server.

At process block 66, the entrepreneur receives the Probability of Compatibility for Profitability Score™ and is encouraged to begin the research into the business opportunity providers that most appeal to the entrepreneur.

The method then terminates at end block 68. The steps are not required to be executed in this order, and one of ordinary skill in the art would appreciate that these steps could be executed in a variety of different manners as well as having two or more of the steps executing simultaneously.

According to an embodiment of the present invention, the methods herein described may be dynamic. In this manner, the methods herein described may immediately change if any of the answers to the profile questionnaire are changed because of plurality of reasons by either the entrepreneur or the business opportunity provider, immediately creating a new ranking based on the new scores calculated by the system herein described. An addition of a new business opportunity to the system may also create the immediate new ranking with corresponding scores for the entrepreneur and that business opportunity.

According to an embodiment of the present invention, the system and methods herein described may be further configured to utilize historical data accumulated over time regarding the successfulness of entrepreneurs and any selected business opportunity. In this manner, the strength of various questions and formula may be tested and validated through success and failures. The system can be configured to automatically associate positive and negative scores with questions and other information based on this historical data.

According to another embodiment of the present invention, any of the previous systems and methods herein described may be utilized with LBS enabled computing devices to enhance the access and awareness of members. Any system or method previously described herein may be further enhanced through the use of LBS enabled computing devices. For instance, an entrepreneur and/or business opportunity providers may be matched and scored based in part on their respective distances and an associated value with which location is important. For example, e-commerce businesses may be less location specific as opposed to service businesses. One of ordinary skill in the art would appreciate that there are numerous ways in which location based services could be utilized with embodiments of the present invention, and embodiments of the present invention are contemplated for use with any manner of utilizing location based services.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer-readable medium that stores computer-executable instructions that are executable by a computer processor, the instructions when executed embodying a method that comprises:
using a computer processor to store, in a tangible computer-readable medium, a plurality of customized methods for generating a compatibility score;
presenting to a user, via a software module stored on said tangible computer-readable medium, an interface for entering data;
receiving input from said user, wherein said input is comprised of a completed profile questionnaire,
wherein said completed profile questionnaire is comprised of a plurality of answers associated with a plurality of questions;
applying a first formula to said plurality of answers in order to generate a plurality of numerical values,
wherein each numerical value of said plurality of numerical values is associated with a question of said plurality of questions;
storing said compatibility score in a tangible computer-readable medium;
grouping said plurality of answers into a plurality of groups,
wherein each group of said plurality of groups has an associated category;
applying a second formula to each numerical value of said plurality of numerical values,
wherein said second formula is configured to modify each numerical value based at least in part on an effect one or more of said plurality of groups has on said numerical value;
generating a group score for each group of said plurality of groups;
generating a compatibility score based at least in part upon one or more of said group scores; and
providing said compatibility score to the user.

2. The system of claim 1, wherein the modifications made by said second formula include augmenting one or more of said numerical values where it is determined there is a high compatibility.

3. The system of claim 1, wherein the modifications made by said second formula include diminishing the scores where it is determined there is a low compatibility.

4. The system of claim 1, wherein the compatibility score is represented as a letter grade.

5. The system of claim 1, wherein said input from said user is further comprised of information received from one or more data sources.

6. The system of claim 5, wherein at least one of said one or more data sources is a browser cache.

7. The system of claim 6, wherein at least one of said one or more data sources is a browser cookie.

8. The system of claim 6, wherein at least one of said one or more data sources is received from a social networking platform.

9. The system of claim 1, wherein said first formula is dynamically configurable.

10. The system of claim 1, wherein said second formula is dynamically configurable.

11. The system of claim 1, wherein said plurality of questions is dynamically configurable.

12. The system of claim 1, wherein said plurality of answers is dynamically configurable.

13. The system of claim 1, wherein said associated category is dynamically configurable.

14. A computer implemented method for providing a compatibility rating used by entrepreneurs to allow them to select business opportunity providers, said method comprising the steps of:
using a computer processor to store, in a tangible computer-readable medium, a plurality of customized methods for generating a compatibility score;
presenting to a user, via a software module stored on said tangible computer-readable medium, an interface for entering data;
receiving input from said user, wherein said input is comprised of a completed profile questionnaire,
wherein said completed profile questionnaire is comprised of a plurality of answers associated with a plurality of questions;
applying a first formula to said plurality of answers in order to generate a plurality of numerical values,
wherein each numerical value of said plurality of numerical values is associated with a question of said plurality of questions;
storing said compatibility score in a tangible computer-readable medium;
grouping said plurality of answers into a plurality of groups,
wherein each group of said plurality of groups has an associated category;
applying a second formula to each numerical value of said plurality of numerical values,
wherein said second formula is configured to modify each numerical value based at least in part on an effect one or more of said plurality of groups has on said numerical value;
generating a group score for each group of said plurality of groups;
generating a compatibility score based at least in part upon one or more of said group scores; and
providing said compatibility score to the user.

15. The method of claim 14, wherein the modifications made by said second formula include augmenting one or more of said numerical values where it is determined there is a high compatibility.

16. The method of claim 14, wherein the modifications made by said second formula include diminishing the scores where it is determined there is a low compatibility.

17. The method of claim 14, wherein the compatibility score is represented as a letter grade.

18. The method of claim 14, wherein said input from said user is further comprised of information received from one or more data sources.

19. The method of claim 18, wherein at least one of said one or more data sources is a browser cookie.

20. The method of claim 18, wherein at least one of said one or more data sources is received from a social networking platform.
